(19) United States
(12) Patent Application Publication
(10) Pub. No.: US 2003/0164851 A1
(43) Pub. Date: Sep. 4, 2003

(54) Method and system for securing credit transactions

(76) Inventor: James E. Smith, Redwood City, CA (US)

Correspondence Address: Jurgen Vollrath, 588 Sutter Street # 531, San Francisco, CA, 94102, US

(21) Appl. No.: 10/346,248

(22) Filed: Jan. 16, 2003

Related U.S. Application Data
(63) Continuation-in-part of application No. 09/894,613, filed on Jun. 27, 2001.
(60) Provisional application No. 60/349,778, filed on Jan. 16, 2002.

(51) Int. Cl. G09G 5/00

(52) U.S. Cl. 345/741

(57) ABSTRACT

In a method of securing credit transactions between a buyer and a merchant, purchaser authenticating information is gathered from the purchaser, and once authenticated, the merchant is authorized. The purchaser is authenticated by enabling the purchaser's machine with enabling software and gathering purchaser authenticating information from the purchaser or by communicating the authenticating information from the purchaser's enabled smart card.

### BACKGROUND OF THE INVENTION

Credit transactions are increasingly being entered into between parties communicating over the Internet. This has led to a considerable amount of fraud resulting in substantial losses to merchants. In an attempt to address the issue, Visa has introduced its Verified by Visa technology which requires a purchaser to include a password or token with his/her credit card number when performing an on-line credit card transaction.

The credit card number and password are authenticated by means of a directory server and, once authorized, the merchant is notified. Unfortunately the technology is extremely onerous to implement by the merchant which detracts from the rapid adoption of the technology. Even in face-to-face transactions making use of a smart card, the merchant requires the implementation of software on his/her machine in order to implement the Verified by Visa technology.

The present invention seeks to address this issue.

### SUMMARY OF THE INVENTION

According to the invention, there is provided a method of securing credit transactions between a buyer and a merchant, comprising requesting purchaser authenticating information from the purchaser, authenticating the purchaser, and authorizing the merchant once the purchaser has been authenticated, wherein the purchaser is authenticated by enabling the purchaser's machine with enabling software and gathering purchaser authenticating information from the purchaser. The purchaser's machine is preferably enabled through the use of a Java Applet. The purchaser authenticating information may include a credit card number of a card to be used in the transaction, a password, demographic information about the purchaser, or any other authenticating information or combinations of such information. The authenticating of the user is typically done through the use of a directory server. The merchant is typically notified by sending a notification to the merchant's computer. Preferably the notification is directed to the merchant's computer via the purchaser's computer for final confirmation of the transaction. Purchaser authentication may include one or more of confirming the merchant,s name, the product being purchased, and the purchase price. The authentication may also include detail about the purchaser such as address information.

In the case of a face-to-face transaction, instead of authenticating the purchaser by enabling his/her machine with enabling software and gathering purchaser authenticating information from the purchaser, the purchaser can provide the authenticating information in the form of a smart card, and the smart card can include enabling code that allows it communicate with an issuing bank computer through the merchant's computer.

### BRIEF DESCRIPTION OF THE DRAWING

FIG. 1 is a diagram illustrating the steps in an on-line credit transaction.

### DETAILED DESCRIPTION OF THE INVENTION

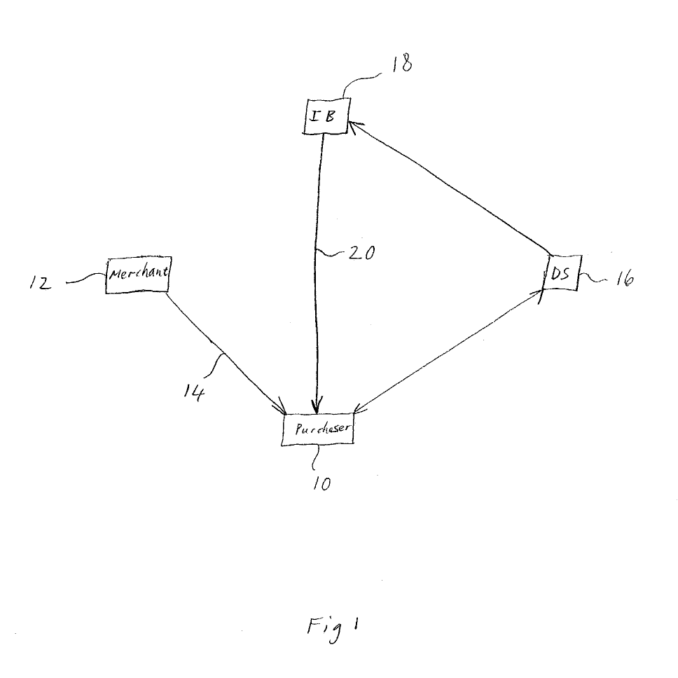

FIG. 1 depicts an on-line credit transaction between a purchaser at a purchaser machine or computer 10 and a merchant at a merchant computer 12. Although the term machine or computer is used for purposes of convenience, it will be understood that any access device could be used such as a set top box, personal digital assistant, etc. The purchaser accesses the merchant's web site as shown by step 14. Once the purchaser has selected an item from the web site and is ready to purchase the item, he/she is prompted to click on a button (such as a “Verified by Visa” button that is being promoted by Visa). Verified by Visa prompts the purchaser to supply his/her credit card number. The credit card number is verified or authenticated against information stored on a directory server 16. Upon authentication by the directory server 16, the directory server 16 communicates the identity of the credit card issuing bank to the purchaser computer 10. In one embodiment, the purchaser computer can use this information to establish a direct communication link with the issuing bank server 18 as is depicted by reference numeral 20. In another embodiment, the purchaser computer 10 could communicate with the issuing bank server 18 through the directory server 16. Next, the user enters a password that is verified or authenticated against information stored on the issuing bank server 18. Once the purchaser is verified, a message that includes a digital signature or other confirmation is sent by the issuing bank server 18 to the purchaser's computer 10, to be submitted by the purchaser to the merchant.

As part of the communications between the purchaser computer 10 and the issuing bank server 18 (either directly or through the directory server 16), transaction information such as merchant identifying information, the item being purchased, and purchase price, are transmitted to the issuing bank by the purchaser computer 10. Any information about the merchant can be used by the issuing bank to authenticate the merchant.

In one embodiment, the message returned by the issuing bank server 18 confirms details about the transaction such as the item or items being purchased, the purchase price, and identifies the merchant. It may also include certain personal details about the purchaser such as the purchaser's shipping address. By passing the information to the purchaser instead of directly to the merchant, the purchaser is given the opportunity to confirm the transaction, cancel the transaction, and in some embodiments, to remove certain personal information that he/she does not wish to transmit to the merchant.

Once the purchaser has confirmed the transaction information and any other information, he/she forwards it to the merchant who finalizes the transaction in a conventional manner by shipping the item to the purchaser and submitting the transaction information to an acquirer for payment. Additionally, a confirmation can be sent to the issuing bank server 18.

In one embodiment of the invention, a Java Applet is sent from the directory server 16 to the purchaser's computer 10 in order to enable the computer 10 with enabling code. The enabled computer allows the computer to communicate with the directory server in accordance with a communication protocol that is discussed in greater detail in concurrently pending application Ser. No. 09/894,613 and subsequent continuation-in-part application, both entitled “Method and System for Communicating User Specific Information” and filed by the same applicant as the current application. These prior applications are included herein by reference.

The protocol allows user specific information to be gathered and used to authenticate the user. Thus, in the present invention, the enabled computer allows the purchaser to locally store user specific information about himself/herself on his/her computer, which can then be used in communications to authenticate the purchaser's identity. Thus, while the above embodiment dealt a Verified by Visa type scenario which uses a credit card number and password for authentication, other information could be used to authenticate the user. By making use of a Java Applet, the enabling code does not have to first be installed on the purchaser's computer in order for the purchaser to reap the benefits of an enable computer. Thus, this embodiment has the advantage that it requires very little purchaser effort. Similarly, since all the authentication of the purchaser takes place between the directory server 16 and purchaser's computer 10, only a minimal amount of software need be installed on the merchant's computer. The merchant's computer merely has to facilitate the initial gathering of user information, e.g. by providing a button such as the Verified by Visa button on the merchant's web site to prompt or extract purchaser authenticating information.

In addition to the on-line transactions discussed above, the present invention also lends itself to face-to-face transactions using a smart card. As discussed in the previously filed applications referenced above, user information can be provided on a portable device such as a smart card. Thus, a smart credit card could be provided with enabling code that allows it to communicate with a directory server when the card is used on a merchant card reader.

While the invention was described with reference to specific embodiments, it will be appreciated that it can be implemented in a variety of ways to achieve the authentication of the user in a credit transaction wherein the substantive authentication steps in the communication are conducted between a purchaser's enabled machine or smart card and an authenticating server.

What is claimed is:

1. A method of securing credit transactions between a buyer and a merchant, comprising
requesting purchaser authenticating information from the purchaser,
authenticating the purchaser, and
authorizing the merchant once the purchaser has been authenticated, wherein the purchaser is authenticated by enabling the purchaser's machine with enabling software and gathering purchaser authenticating information from the purchaser.

2. A method of claim 1, wherein the purchaser's machine is enabled through the use of a Java Applet.

3. A method of claim 1, wherein the purchaser authenticating information includes a credit card number of a card to be used in the transaction, a password, demographic information about the purchaser, or any other authenticating information or combinations of such information.

4. A method of claim 1, wherein the authenticating of the user is done through the use of a directory server.

5. A method of claim 1, wherein the merchant is notified of the authentication results by sending a notification to the merchant's computer.

6. A method of claim 5, wherein the notification is directed to the merchant's computer via the purchaser's computer for final confirmation of the transaction.

7. A method of claim 1, wherein authentication includes at least one of confirming the merchant name, the product being purchased, and the purchase price, and detail about the purchaser.

8. A method of securing credit transactions between a buyer and a merchant, comprising
requesting purchaser authenticating information from the purchaser,
authenticating the purchaser, and authorizing the merchant once the purchaser has been authenticated, wherein the purchaser provides authenticating information in the form of a smart card, and the smart card includes enabling code that allows it to communicate with an issuing bank computer through the merchant's computer.
